(19) United States
(12) Patent Application Publication
(10) Pub. No.: US 2010/0046033 A1
(43) Pub. Date: Feb. 25, 2010

(54) Method to Improve Image on Paper Registration Measurements

(75) Inventors: Rakesh Suresh Kulkarni, Webster, NY (US); Daniel W. Costanza, Webster, NY (US); Abu Saeed Islam, Rochester, NY (US); Daniel S. Hann, Williamson, NY (US)

Correspondence Address: Hoffmann & Baron, LLP, 6900 Jericho Turnpike, Syosset, NY, 11791, US

(73) Assignee: Xerox Corporation, Norwalk, CT (US)

(21) Appl. No.: 12/194,958

(22) Filed: Aug. 20, 2008

(51) Int. Cl. G06K 15/00

(52) U.S. Cl. 358/1.18

(57) ABSTRACT

A method of controlling the placement of images on output of a printer, including determining scanner spatial error using an ideal medium having a first two-dimensional array on the ideal medium then determining printer spatial error using a second medium having a second two-dimensional array; and finally, controlling placement of images on the output of the printer based on the scanner spatial error and the printer spatial error.

### BACKGROUND

1. Technical Field

Embodiments disclosed herein relate to printing systems and, more particularly, to systems and techniques for controlling placement of images by image transfer systems.

2. Brief Description of Related Art

In various reproduction systems, including xerographic printing, the control and registration of the position of imageable surfaces such as photoreceptor belts, intermediate transfer belts, if any, and/or images on such imageable surfaces, and the control and registration of images transferred to and developed on a medium, such as for example, a sheet of paper, involve both initial and process control methods.

Today, one of the more advanced techniques for controlling image placement is by scanning the medium on a flatbed scanner. The measurements used, however, are limited to sheets smaller than the full capacity of a printer primarily due to the size of the scanner and the method of analysis. In addition, the precision of measurements tend to be limited by the accuracy of the scanner itself. Furthermore, some techniques tend to use only a few (3-4) points on the page for measurement, thus limiting the information that is gathered. As such, there is no opportunity to use averaging to help interpret spatial errors, nor is there enough information to understand the signature of the errors.

Systems for control of image placement provided by conventional measurements are typically limited. For example, in most conventional systems, only printer spatial errors at the corners of a sheet are determined. For larger media, the measurement process is typically performed manually. Errors that occur during printing or scanning can be caused by, for example, Raster Output Scanner (ROS) scan line bow, ROS magnification, lateral errors, and skew errors, which cannot be determined from measurements taken using conventional techniques. Fuser shrinkage can also result in errors that have well defined intra sheet signatures. Accordingly, there is a need for a measurement system and techniques that would provide control of image placement in a more precise manner and enable show through registration measurement.

### SUMMARY

A system and method of controlling the placement of images on output of a printer in a precise manner are disclosed. The system and methods can determine both scanner spatial error and printer spatial error by using an ideal medium, for example a film, that has a two-dimensional array on the film and a second medium, for example a sheet of paper, having a second two-dimensional array on the sheet of paper. The system and methods control the placement of images on the output of the printer based on the scanner spatial error and the printer spatial error. The first two-dimensional array can be a grid of at least one geometric shape, for example dots, on the film. The second two-dimensional array can be a second grid of at least one geometric shape substantially similar to the first grid of at least one geometric shape. At least one of the first and second grids of at least one geometric shape can have fiducial marks. The positional information associated with each of the grids is compared in order to determine the spatial error. As there are multiple registration measurements throughout the medium, individual spatial errors in the scanner or printer, and their unique signatures within a printed medium can be determined. Use of multiple measurements allows identification of individual error contributors.

The system and methods can utilize separate measurements of both printed sides of a medium, for example a sheet of paper, and employ a common sheet based coordinate system that enables duplex registration (show through) measurements. The method includes identifying a common reference between the first side (Side1) and the second side (Side2) of the sheet of paper. Specifically, identifying a leading edge of a sheet of paper as a first axis; identifying a perpendicular distance to a corner of the leading edge as a second axis; and measuring the location of geometric shapes in the two-dimensional array on Side1 and Side2 using the first and second axes.

In another aspect, a system controls the placement of images on output of a printer. The system includes a processor and memory storing instructions that, in response to receiving a request to control placement of images on output of a printer, activates the processor. The system causes the processor determine spatial errors by scanning an ideal medium that has a first two-dimensional array on the ideal medium; then scan a second medium that has a second two-dimensional array on the printer in response to the request. The system then controls the placement of images on the output of the printer based on the spatial error. Accordingly, the present system and techniques can efficiently adjust for the above-identified errors.

By measuring more points in order to determine error, the system can provide an enhanced representation of what a printer user may view. For example, users typically judge printer performance on the accuracy of the entire image printed. The more points used to control the placement of images, the more accurately a printed image is depicted. Therefore, the more points used to control image placement, the more likely a user will be satisfied by the resulting image. This is especially true when printing pictures, ballots, business cards and other images requiring a high degree of accuracy. Control of the digital copier with two-dimensional array measurements better reflects performance because accuracy is judged beyond the four corners of the printed paper.

Another advantage of the system relates to obtaining better resolution. For example, by using additional measurement points the system can be used to parse and understand individual error sources (e.g., printer or scanner spatial errors, magnification errors, ROS bow, etc.) In one embodiment, the system performs several measurements to accurately define each of the error source signatures. For example, a magnitude of error of each point can be independently displayed. By averaging the results of errors across an entire print area, error amplitudes can be established with precision. High dpi scanners can also be used with the system to achieve these results.

Positional scanning accuracy of scanners are typically in the 1 mm range over the length of the scan (i.e., approximately 430 mm). It is advantageous to achieve lower than about 1 mm over the length of the scan, using an uncorrected scanner to determine printer spatial error is typically not appropriate. Accordingly, the system can employ a method that can be used for any imaging device, such as a flatbed scanner, resulting in improved image placement.

Additional features and advantages will be readily apparent from the following detailed description, the accompanying drawings and the claims. It is to be understood, however, that the drawings are designed as an illustration only and not as a definition of the limits of the disclosure.

### BRIEF DESCRIPTION OF THE DRAWINGS

FIG. 1 illustrates a block diagram of a system for controlling image placement.

FIG. 2 illustrates an example two-dimensional array.

FIG. 3 illustrates an example simplex and duplex IOP registrations, respectively.

FIG. 4 illustrates an example of specifications for an ideal film.

FIG. 5 illustrates an example of image on film, and image on print alignment, respectively.

FIG. 6 illustrates an example of stored scanner spatial errors pictorially.

FIG. 7 illustrates an example of calculation of total printer spatial error.

FIG. 8 illustrates examples of error source signatures.

FIG. 9 illustrates an example of duplex IOP registration.

FIG. 10 is a flow chart of the control of image placement process.

FIG. 11 illustrates an example of a digital copier.

Like reference symbols in the various drawings indicate like elements.

### DETAILED DESCRIPTION

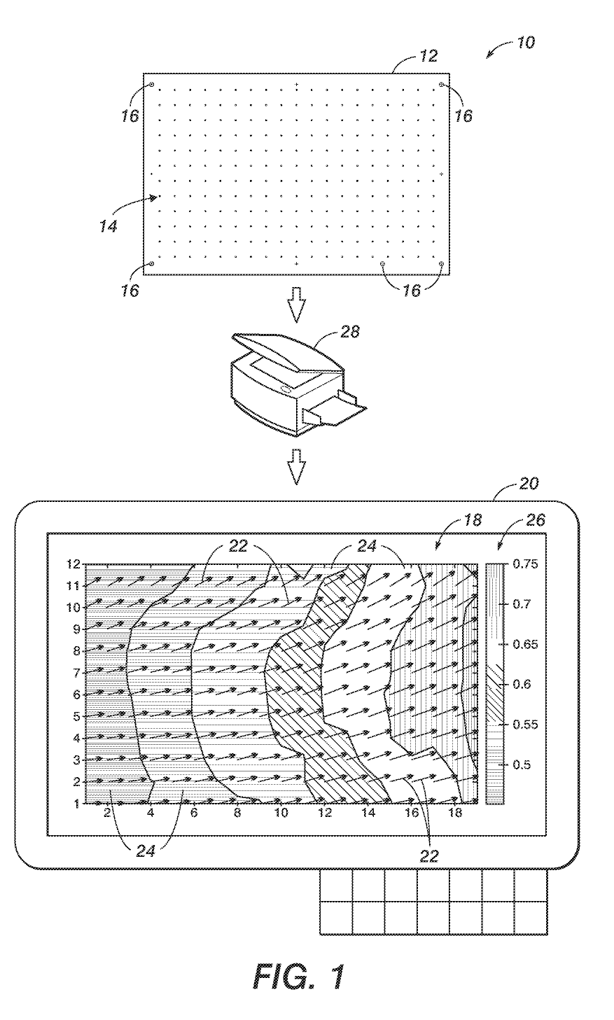

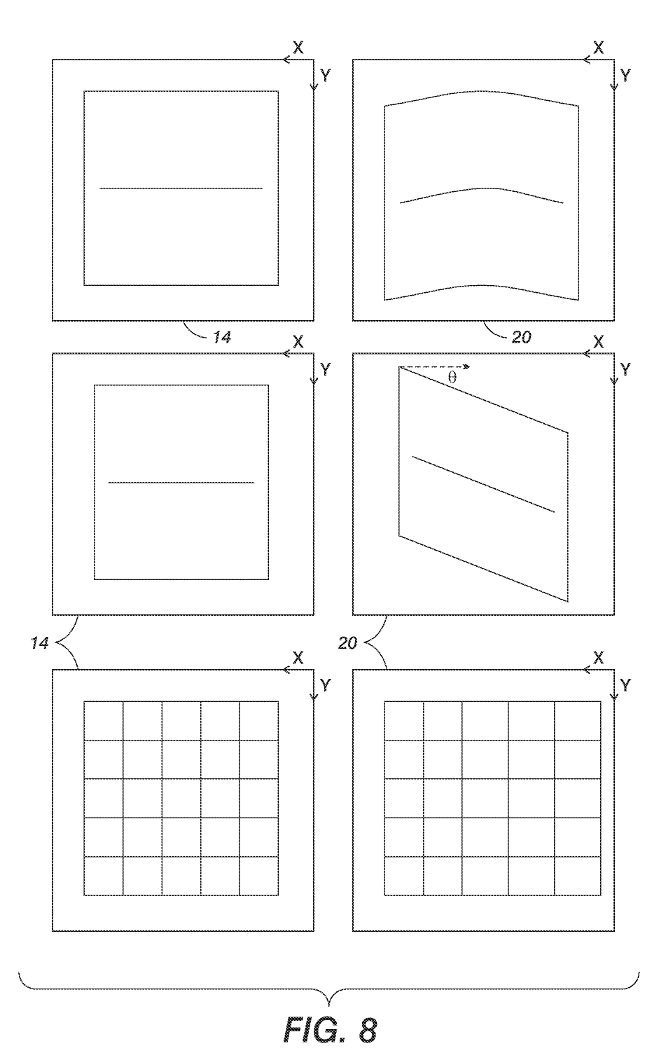

Referring now to FIGS. 1-11, a system 10 and method for precisely controlling the placement of images throughout a medium 12 (for illustrative purposes only hereinafter, described as a sheet 12) are disclosed.

As used herein, the phrase “IOP registration” refers to measurements that identify the position of a two-dimensional array with respect to a position and corners of a medium, such as a sheet of paper.

As used herein, the phrase “controlling the placement of images” or “controlling image placement” refer to adjusting an digital copier based on total error, for example a scanner and printer whereby the scanner spatial error and printer spatial error are each determined and the digital copier is adjusted accordingly.

As used herein, the term “media” or “medium” refers to any tool used to store or deliver information, for example a sheet of paper, film, files, etc.

As used herein, the phrase “digital copier” refers to a device capable of transferring an image to a medium, for example a scanner, printer, camera or a photoplotter.

As used herein, the term “centroid” refers to a point at a geometric center of a geometric shape.

As used herein, the phrase “show through” refers to a relative position of a printed two-dimensional array on one side of a medium to the position of a printed two-dimensional array on the other side of the same medium.

As used herein, the phrase “fiducial mark” refers to a mark defining a datum point or standard of positional reference used as a basis for calculation or measurement.

As used herein, the phrases “ideal medium” and “ideal media” refer to the media used as a standard to control placement of images by a digital copier, for example the terms “ideal film” or “ideal virtual file” are “ideal media.”

As used herein, the phrase “positional information” refers to a location occupied by the centroid of a geometric shape on a medium relative to a fiducial mark or coordinate point within the same medium.

As used herein, the phrase “spatial error” refers to the variation in positional information between and ideal medium and a second (scanned, printed, or otherwise transferred) medium.

As used herein, a term “two-dimensional array” refers to any grouping of at least one geometric shape throughout a medium, such as dots covering a sheet of paper.

The system 10 detects the differences in positional information associated with a two-dimensional array on “ideal” media and a scan of the same two-dimensional array, so as to isolate scan errors. System 10 detects the differences in positional information associated with a scan and the ideal virtual file by deriving coordinate information from the scan and from the ideal virtual file. Algorithms are used to find the centroids of geometric shapes (for illustrative purposes only, hereinafter dots) forming the two-dimensional array. Using the coordinate information from the position and corners of the scan, one corner is designated the (0,0) coordinate. Based on the margin of error between the “ideal” coordinate of each centroid and the actual coordinate of that centroid in the scan, a margin and magnitude of spatial error is determined for each dot forming the two-dimensional array.

Referring now to FIG. 1, in some embodiments, system 10 can be embodied in a single device, such as digital copier 28. It is conceivable that system 10 can be embodied in a combination of separate devices, such as, for example, a printer, or a stand alone scanner, general-purpose computer, network-controlled printer, or multipurpose device. The system 10 can also be embodied in a facsimile machine. For illustrative purposes only, the following description of system 10 will be embodied in a digital copier 28.

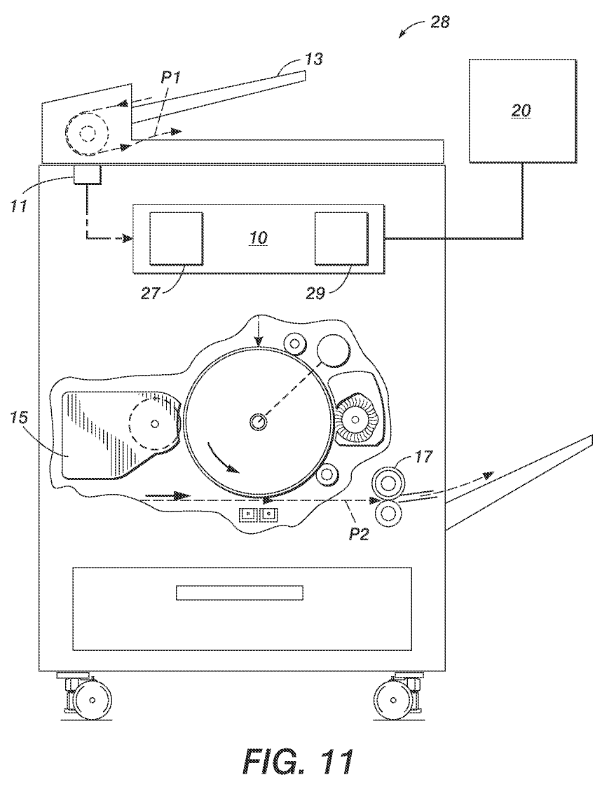

Referring now to FIG. 11, the digital copier 28, for illustrative purposes only, is hereinafter described as a scanner 28 having copier and printer capabilities. Scanner 28 can include any number of processors 27 and memory devices 29. Sheet 12 can be placed on the platen or input tray 13 of scanner 28. As sheet 12 enters scanner 28 it passes over photosensor array 11 which determines the location of leading edge of the paper 12. The photosensor array 11 determines the exact distance of the leading edge of sheet 12 relative to some fixed point within the scanner 28.

As sheet 12 is scanned by scanner 28 the sheet 12 can be illuminated and recorded by a photosensor array 11 (e.g., charge-coupled device or CMOS device along with certain optics). The photosensor array 11 converts reflected light into digital data which can be retained by system 10. System 10 can convert scanned sheet 12 to a virtual file (eg: TIFF, .jpeg, .gif, or others known in the art) or operate printing features 15. Scanner 28 can have “duplex” capabilities enabled by duplexer 17, i.e., the ability to scan from and/or print on both sides of a sheet 12.

Programs operating within system 10 can perform certain image manipulation operations on image data between recordation by, for example, a photosensor array and, for example, printing (or creating an image file). For example, system 10 can effect a magnification or reduction of the original image in the images on the output sheet or file. The magnification or reduction can be effected in horizontal and/or vertical dimensions in the resulting images.

With further reference to FIG. 1, measurement errors determined by the system 10 are shown in a pictorial 18. The pictorial 18 can be provided on a display device 20, such as a computer monitor, or alternatively, can be printed by scanner 28. The pictorial 18 illustrates the direction of measurement errors using arrows 22 and magnitudes of the error using colors 24. A color scale 26 also is provided that facilitates user interpretation of the colors 24. The system 10 can provide printer spatial errors across the entire sheet, not only the corners as practiced by most systems in the art.

In order to improve the IOP, system 10 can isolate and account for scanner spatial error prior to printing. System 10 can determine the differences between spatial information associated with the two-dimensional array of the scan produced and that of the ideal virtual file. Upon scanning the two-dimensional array 14, the system 10 stores centroid information in a spreadsheet format, compares the location of scanned dot centroids to a stored ideal virtual version of the two-dimensional array, and then calculates measurement errors for each dot location. The system 10 employs techniques known in the art to determine the centroids of the dots.

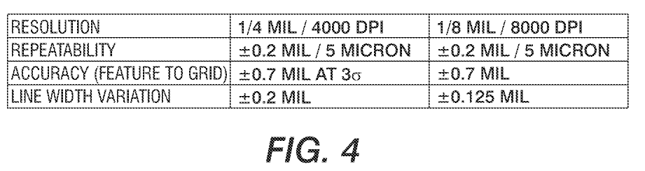

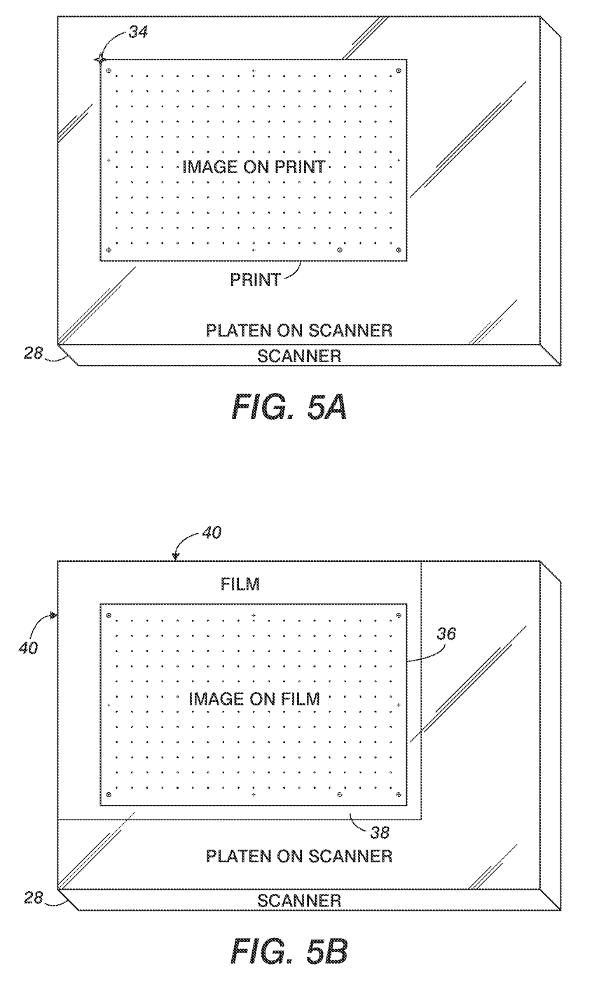

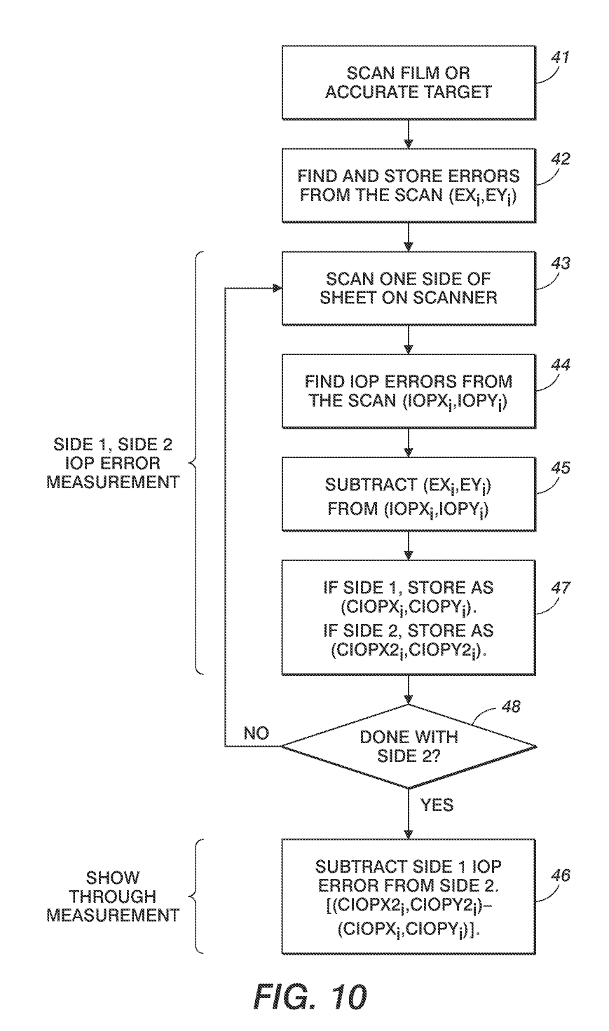

An example of isolating and calculating scanner spatial errors prior to printing is described in FIG. 10, steps 41 and 42. Isolation of scanner spatial error involves adjusting scanner 28 output relative to a two-dimensional array in an ideal virtual file. The two-dimensional array is stored as an ideal virtual file. First, the two-dimensional array is used to substantially cover an ideal film or other stable media (hereinafter, for illustration only, referred to as film 38) using a photoplotter to produce a two-dimensional array on a film. (An example specification for the film that can be used with the system is shown in FIG. 4.) Referring to FIG. 5, a first two-dimensional array 36 on a film 38 is centered such that edges 40 of the film 38 align with edges of the scanner 28.

The film 38 is then scanned, step 41, on the scanner 28 and post processed, by comparing the two-dimensional array in the scan of the film 38 to the actual locations in the ideal virtual file, to calculate and store scanner spatial errors, step 42, for each of the dots throughout the two-dimensional array. The scan of the two-dimensional array 36 of film 38 can be identical to the ideal virtual file. Any variation from the two-dimensional array 36 on film 38 can be detected and calculated as scanner spatial errors, which can be saved to a file.

For example, if there are a number (n) of dots imprinted on the film (F) 38 then for the centroid of each dot, with respect to fiducial marks (discussed in greater detail below), there is a specific X,Y coordinate (FX₁₋ₙ,FY₁₋ₙ). The ideal virtual file used to photoplot the two-dimensional array 36 onto film 38 contains the ideal locations of the centroids of these dots with respect to the fiducial marks on the film 38 (IX₁₋ₙ, IY₁₋ₙ). The error detection may be described by the following calculation:

For i=1 to n (dots)

FXᵢ−IXᵢ=EXᵢ and FYᵢ−IYᵢ=EYᵢ (Scanner)

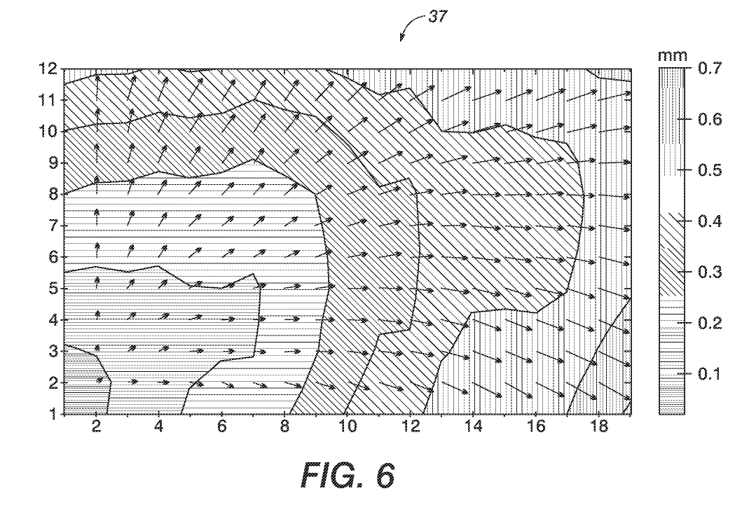

The errors of n dots (EX₁₋ₙ, EY₁₋ₙ) are stored as a scanner spatial errors file depicted as pictorial 37 in FIG. 6. The scanner will then account for the error in future items scanned.

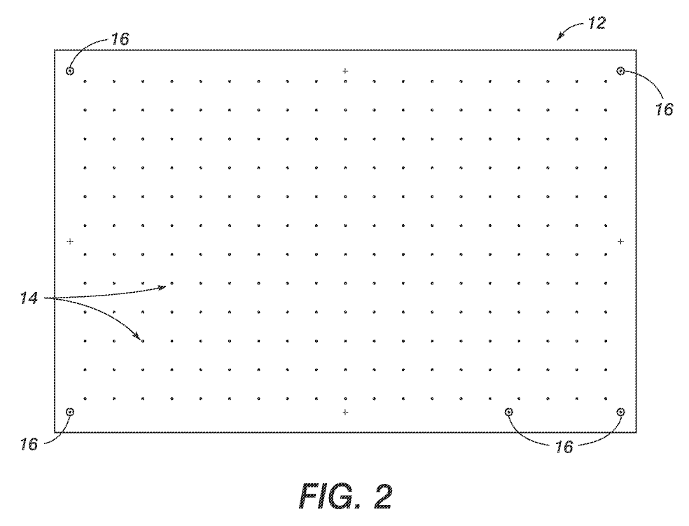

In some embodiments, IOP printer spatial error is determined by the system 10. System 10 accesses an ideal virtual file to print a sheet 12 having a two-dimensional array 14 that is defined by a grid of dots substantially covering the sheet 12. An example of the two-dimensional array 14 included on the sheet 12 is shown in further detail in FIG. 2. For example, in one embodiment, over two hundred (200) dots are arranged to substantially cover the sheet 12. The two-dimensional array 14 also can include multiple fiducial marks 16 that can be used for alignment during analysis. For example, the sheet 12 can include at least five (5) fiducial marks or bullseyes for alignment of the sheet 12.

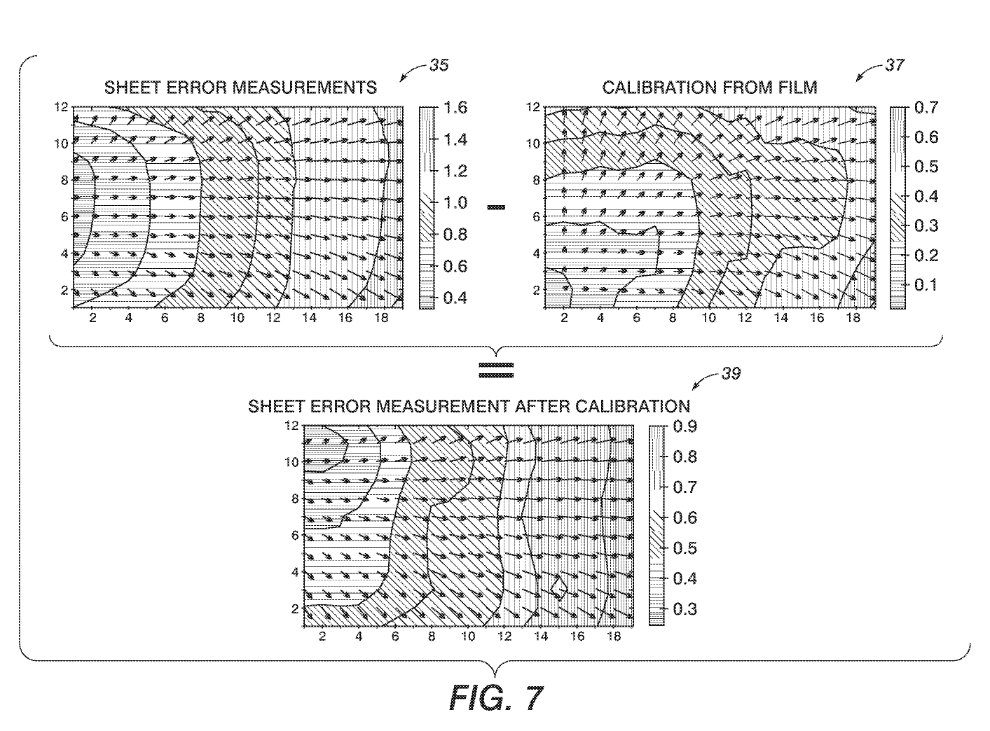

Upon printing, sheet 12 can then be scanned. A location for a sheet 12 to be placed on a platen of the scanner 28 is marked so that the sheet 12 is placed at a substantially identical location as the ideal media (e.g., film 38) used to isolate scanner spatial errors. An example marked location is shown as the star mark 34 in FIG. 5. The sheet 12, having the printed two-dimensional array 36 is then scanned. As a result, the two-dimensional array 36 on the film 38 is at the substantially identical location on the scanner 28 as a sheet 12 to be scanned (shown in FIG. 5). The scan of sheet 12 is then compared to the ideal virtual file. If this method is used, printer spatial error for any printer can be determined, not just printers operatively connected to a specific scanner. Alternatively, printed sheet 12 can be visually compared to film 38 and then the printer spatial error can be manually calculated. Pictorial 35 of FIG. 7 displays an example of printer spatial errors. System 10 can account for scanner spatial error 37 previously isolated to identify errors specific to the printer.

Referring to FIG. 7, the stored scanner spatial errors file determined above is used by the system 10 to calculate printer spatial errors for Side1 (e.g., simplex) measurements, step 43 (FIG. 10). In one embodiment, the stored scanner spatial errors file contains errors for some or all of the dots in the scan of film 38 due to scanner spatial error 37 (EX₁₋ₙ, EY₁₋ₙ) determined above. The system 10 then subtracts measurement values included in this file 37 from the Side1 printer spatial error measurements 35 of the dots to provide final results for Side1, 39. For example, the corrected IOP for Side1 (CIOP) is calculated, step 45 as follows:

For i=1 to n (1-n)

(CIOPX1ᵢ₋ₙ,CIOPY1ᵢ₋ₙ)=(X1ᵢ₋ₙ−IX1ᵢ₋ₙ−EXᵢ₋ₙ,Y1ᵢ₋ₙ−IY1ᵢ₋ₙ−EYᵢ₋ₙ)

An example of the final results 42 is shown in FIG. 7.

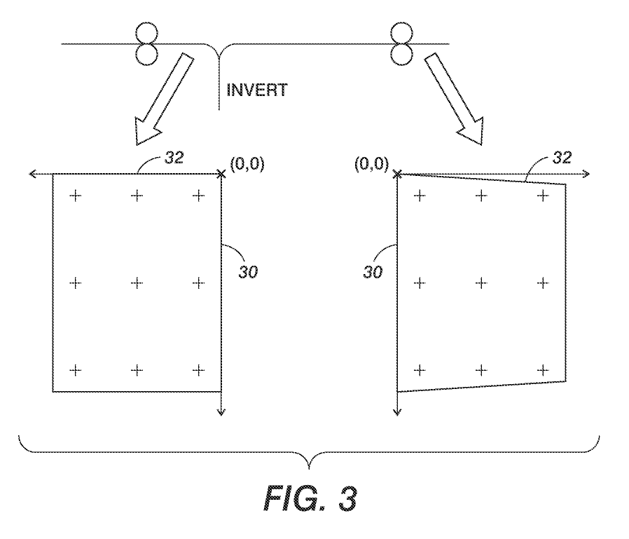

In some embodiments, system 10 measures Side1-Side2 (e.g., duplex) IOP registration (show through) using a coordinate system that applies a common reference to both sides of a sheet 12. For example, as shown in FIG. 3, a leading edge 30 of the sheet 12 can be detected and used as the reference edge and serves as a first axis of the coordinate system. System 10 determines a second axis, top edge 32 of the coordinate system by measuring a perpendicular drawn to a corner of leading edge 30. Regardless of how sheet 12 moves through, for example, a scanner 28, leading edge 30 of Side1 is also the leading edge 30 of Side2. The system 10 then measures both sides of the sheet with respect to the same leading edge and compares Side1 to Side2 to obtain resultant Side1-Side2 IOP spatial errors.

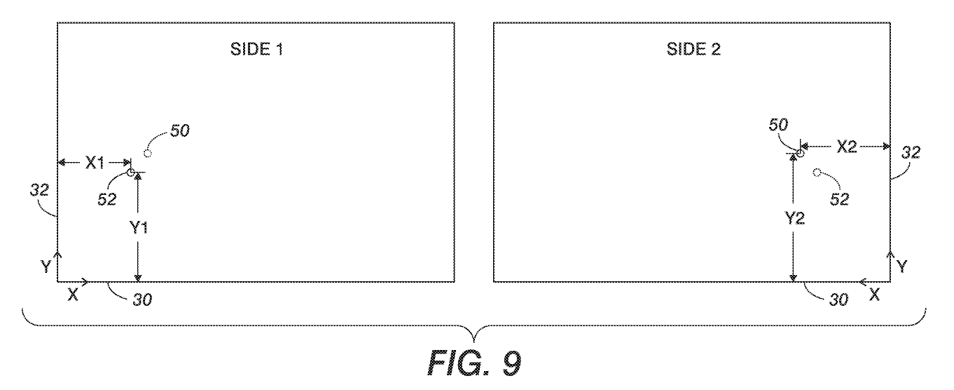

Errors between Side1 and Side2 determined by system 10 can be better understood through the following example of show through errors in duplex printing. For example, an ideal Side1 and Side2 each exhibit a dot located so that there is zero show through when printed. However, due to a print error, the dots on Side1 and Side2 are misaligned and show through. With reference to FIG. 9, system 10 detects error(s) (or lack thereof) by utilizing leading edge 30 as the X-axis and top edge 32 as the Y axis. Coordinates (X1, Y1) represent location of dot 52 on Side1 and the ideal location (i.e., that stored on the film or other stable media or in a digital image file) of dot 52 is (IX1, IY1). Accordingly, system 10 determines the error(s) of dot 52 as (X1, Y1)=(X1−IX1, Y1−IY1). When side 1 is scanned (FIG. 10 step 43), if there are n marks on Side 1, the error(s) will be calculated (step 44):

For i=1 to n

(X1ᵢ₋ₙ,Y1ᵢ₋ₙ)=(X1ᵢ₋ₙ−IX1ᵢ₋ₙ,Y1ᵢ₋ₙ−IY1ᵢ₋ₙ) (Side 1)

A determination will also be made by the system 10 for error(s) on Side2. Accordingly, system 10 defines dot 50 using the same coordinates for X and Y (i.e. X is represented by leading edge 30, Y by top edge 32). System 10 uses positive integrals for X and Y on both Side1 and Side2. Dot 52 is defined by the system as (X2,Y2) and the ideal location of dot 52 is (IX2,IY2). The system calculates the error(s) for Side2 (step 48) using the same equation as above:

For i=1 to n

(X2ᵢ₋ₙ,Y2ᵢ₋ₙ)=(X2ᵢ₋ₙ−IX2ᵢ₋ₙ,Y2ᵢ₋ₙ−IY2ᵢ₋ₙ) (Side 2)

Using the error for each dot on each side based on the same coordinates, allows for accurate adjustment to ensure proper printing on both sides of a paper.

In yet another embodiment, measurement errors can be detected based on both scanner error (steps 41 and 42) and duplex errors (steps 43, 44, 45, 47, 48, and 46). The detection of scanner spatial errors and duplex errors, employed by the present system 10 can be used for controlling placement of any imaging device such as a scanner, camera, etc. Measurement errors can be detected based on scanner inaccuracy and duplex errors.

For Side2 calibration, step 48, the same scanned film image is used. The only difference is that while creating the calibration file for Side2 (e.g., duplex), the system post processes the measurement using the coordinate system of Side2. Accordingly, the corrected IOP (CIOP) for Side2 is calculated as follows:

For i=1 to n (1-n)

(CIOPX2ᵢ₋ₙ,CIOPY2ᵢ₋ₙ)=(X2ᵢ₋ₙ−IX2ᵢ₋ₙ−EXᵢ₋ₙ,Y2ᵢ₋ₙ−IY2ᵢ₋ₙ−EYᵢ₋ₙ)

Show through measurements, step 46, can also be calculated based on the corrected IOP information accordingly:

For i=1 to n (1-n)

(CIOPX2i,CIOPY2)−(CIOP1Xi,CIOP1Yi)=show through error

In certain embodiments, the direction of errors calculated by the system 10 is shown by arrows and magnitudes of error are shown in color.

It will be appreciated that several of the above-disclosed and other features and functions, or alternative thereof, may be desirably combined into many other different systems or applications. Various presently unforeseen or unanticipated alternatives, modifications, variations, or improvements therein may be subsequently made by those skilled in the art which are also intended to be encompassed by the following claims. In addition, the claims can encompass embodiments in hardware, software, or a combination thereof.

1. A method of controlling the placement of images on output of a printer comprising:
scanning an ideal medium having a first two dimensional array thereon, thereby determining scanner spatial error;
determining printer spatial error using a second medium having a second two-dimensional array on the printer; and
controlling placement of images on the output of the printer based on the scanner spatial error and the printer spatial error.

2. The method of claim 1, wherein the first two-dimensional array comprises a first grid of at least one geometric shape substantially covering the ideal medium.

3. The method of claim 2, wherein the second two-dimensional array comprises a second grid of at least one geometric shape substantially similar to the first grid of geometric shapes.

4. The method of claim 3, comprising comparing positional information associated with the at least one geometric shape included in the first grid of at least one geometric shape to corresponding positional information associated with the at least one geometric shape in the second grid.

5. The method of claim 4, wherein at least one of the first and second grids of the at least one geometric shape comprises fiducial marks and the second medium is formed from paper.

6. The method of claim 1, comprising:
scanning a first and second side of the second medium, the first and second sides each comprising the second two-dimensional array;
determining printer spatial error for the first and second sides; controlling placement of images on the output of the printer based on the scanner spatial error and the printer spatial error.

7. The method of claim 6, comprising identifying a common reference between the first and second sides of the second medium.

8. The method of claim 7, wherein determining printer spatial error:
identifying a leading edge of the second medium as a first axis;
identifying a perpendicular distance to a corner of the leading edge as a second axis; and
measuring said first and the second side using the first and second axes.

9. The method of claim 1, wherein at least one of the scanning, determining, or controlling, is performed by at least one of a digital copier, camera, scanner, printer, and photoplotter.

10. The method of claim 1, comprising displaying the printer spatial error and scanner spatial error graphically.

11. A system for controlling the placement of images on output of a printer, comprising a digital copier operatively coupled to a display device, the digital copier including a processor and memory storing instructions that, in response to receiving a request to control placement of images on output of a printer, cause the processor to:
determine spatial errors of the digital copier using an ideal medium having a first two-dimensional array on the ideal medium;
scan a second medium comprising a second two-dimensional array on the printer in response to the request; and
controlling the placement of images on the output of the printer based on the spatial error.

12. The system of claim 11, wherein the first two-dimensional array comprises a first grid of at least one geometric shape substantially covering the ideal medium.

13. The system of claim 12, wherein the second two-dimensional array comprises a second grid of at least one geometric shape substantially similar to the first grid of at least one geometric shape.

14. The system of claim 13, wherein the processor compares positional information associated with the at least one geometric shape included in the first grid of at least one geometric shape to corresponding positional information associated with the at least one geometric shape of the second grid.

15. The system of claim 14, wherein at least one of the first and second grids of at least one geometric shape comprises fiducial marks.

16. The system of claim 11, wherein in response to a second request, the processor:
scans a first and second side of the second medium, the first and second side each comprising the second two-dimensional array; and
controlling placement of images on the output of the printer based on the spatial error.

17. The system of claim 16, wherein the processor identifies a common reference between the first and second sides of the second medium.

18. The system of claim 17, wherein the processor identifies a leading edge of the second medium as a first axis, identifies a perpendicular distance to a corner of the leading edge as a second axis, and measures the first and the second side using the first and second axes.

19. The system of claim 11, wherein at least one of the scan, determine, or control, is performed by at least one of a camera, scanner, printer, and photoplotter.

20. The system of claim 11, wherein spatial error is displayed graphically on the display device.
